(19) United States
(12) Patent Application Publication
(10) Pub. No.: US 2017/0074171 A1
(43) Pub. Date: Mar. 16, 2017

(54) GAS TURBINE PLANT AND METHOD OF IMPROVING EXISTING GAS TURBINE PLANT

(71) Applicant: MITSUBISHI HITACHI POWER SYSTEMS, LTD., Kanagawa (JP)

(72) Inventors: Kodai TAKENAKA, Kanagawa (JP); Shinichi YAMAZAKI, Kanagawa (JP)

(21) Appl. No.: 15/264,941

(22) Filed: Sep. 14, 2016

(30) Foreign Application Priority Data
Sep. 15, 2015 (JP) 2015-181928

(51) Int. Cl. F02C 9/18; F02C 3/30; F02C 7/18; F02C 7/224; F02C 3/04; F02C 7/141

(52) U.S. Cl. CPC F02C 9/18; F02C 3/04; F02C 7/141; F02C 7/18; F02C 7/224; F02C 3/30; F05D 2220/32; F05D 2230/60; F05D 2230/80; F05D 2240/35; F05D 2260/213

(57) ABSTRACT

A gas turbine plant comprises: a gas turbine having a compressor configured to compress air, a combustor configured to mix compressed air compressed by the compressor with fuel to generate combustion gas, a turbine connected to the compressor and configured to acquire rotary power by the combustion gas, and an air bleeding piping configured to supply the compressed air bled off from the compressor to the turbine as cooling air; and an auxiliary compressed air supply apparatus having a separately placed compressor different from the compressor, a motor configured to rotate the separately placed compressor, and an auxiliary compressed air piping configured to connect the separately placed compressor to the air bleeding piping to supply auxiliary compressed air compressed by the separately placed compressor to the air bleeding piping. The gas turbine further includes a cooling apparatus connected to the air bleeding piping and configured to cool down the cooling air.

### CROSS-REFERENCE TO RELATED APPLICATION

The present application claims priority to and incorporates by reference the entire contents of Japanese Patent Application No. 2015-181928 filed in Japan on Sep. 15, 2015.

### FIELD

The present application relates to a gas turbine plant, and a method of improving an existing gas turbine plant.

### BACKGROUND

Conventionally, a gas turbine plant has a compressor, a combustor, and a turbine, and generates combustion gas by causing the combustor, to which fuel is supplied, to combust air compressed by the compressor. By supplying the generated combustion gas to the turbine and rotating the turbine, thermal energy is converted into rotational energy.

In Japanese National Publication of International Patent Application No. 2002-519580, a configuration is described, in which a compressor that is separately placed from a compressor connected to a turbine of a gas turbine plant is provided, and which supplies air compressed by the separately placed compressor to the gas turbine plant.

By providing a separately placed compressor like in the apparatus described in the Patent Literature above to increase flow rate of supplied air, even in an environment where temperature of outside air is high and air having low air density is drawn in, reduced output of the gas turbine plant is able to be increased. However, in the apparatus described in the Patent Literature above, increase in load applied to the gas turbine by the compressed air supplied from the separately placed compressor may become larger.

### SUMMARY

It is an object of the present disclosure to at least partially solve the problems in the conventional technology.

In one aspect, there is provided a gas turbine plant, comprising a gas turbine having a compressor configured to compress air, a combustor configured to mix compressed air compressed by the compressor with fuel to generate combustion gas, a turbine connected to the compressor and configured to acquire rotary power by the combustion gas, and an air bleeding piping configured to supply the compressed air bled off from the compressor to the turbine as cooling air, and an auxiliary compressed air supply apparatus having a separately placed compressor different from the compressor, a motor configured to rotate the separately placed compressor, and an auxiliary compressed air piping configured to connect the separately placed compressor to the air bleeding piping to supply auxiliary compressed air compressed by the separately placed compressor to the air bleeding piping, wherein the gas turbine includes a cooling apparatus connected to the air bleeding piping and configured to cool down the cooling air.

In one aspect, there is provided a method of improving an existing gas turbine plant comprising: a compressor arranged in a turbine building; a combustor arranged in the turbine building and configured to mix compressed air compressed by the compressor with fuel to generate combustion gas; a turbine arranged in the turbine building and configured to acquire rotary power by the combustion gas; an air bleeding piping configured to supply the compressed air bled off from the compressor to the turbine as cooling air; and a cooling apparatus connected to the air bleeding piping and configured to cool down the cooling air, the method comprising: arranging, outside the turbine building, auxiliary compressed air supply equipment including a separately placed compressor configured to generate compressed air and a motor configured to drive the separately placed compressor; and connecting an auxiliary compressed air piping, through which the auxiliary compressed air generated by the separately placed compressor of the auxiliary compressed air supply equipment flows, to a portion of the air bleeding piping, the portion being arranged outside the turbine building.

The above and other objects, features, advantages and technical and industrial significance of this disclosure will be better understood by reading the following detailed description of disclosed embodiments, when considered in connection with the accompanying drawings.

### BRIEF DESCRIPTION OF THE DRAWINGS

FIG. 1 is a diagram of a schematic configuration illustrating an example of a gas turbine plant according to a first embodiment.

FIG. 2 is a diagram of a schematic configuration illustrating an example of a gas turbine according to the first embodiment.

FIG. 3A is an explanatory diagram illustrating an example of operation of the gas turbine plant according to the first embodiment.

FIG. 3B is an explanatory diagram illustrating an example of the operation of the gas turbine plant according to the first embodiment.

FIG. 4A is a diagram of a schematic configuration illustrating an example of a method of improving an existing gas turbine plant.

FIG. 4B is a diagram of a schematic configuration illustrating an example of the method of improving an existing gas turbine plant.

FIG. 4C is a diagram of a schematic configuration illustrating an example of the method of improving an existing gas turbine plant.

FIG. 5 is a diagram of a schematic configuration illustrating an example of a gas turbine plant according to a second embodiment.

FIG. 6 is a diagram of a schematic configuration illustrating an example of a gas turbine and an auxiliary compressed air supply apparatus, according to the second embodiment.

### DETAILED DESCRIPTION

Hereinafter, the present disclosure will be described in detail, with reference to the drawings. The present disclosure is not limited by the following modes (hereinafter, referred to as “embodiments”) for carrying out the disclosure. Further, components in the embodiments described below include any component easily supposed by those skilled in the art, any component that is substantially the same, and any component of so-called equivalent scope. Furthermore, the components disclosed in the following embodiments maybe combined as appropriate.

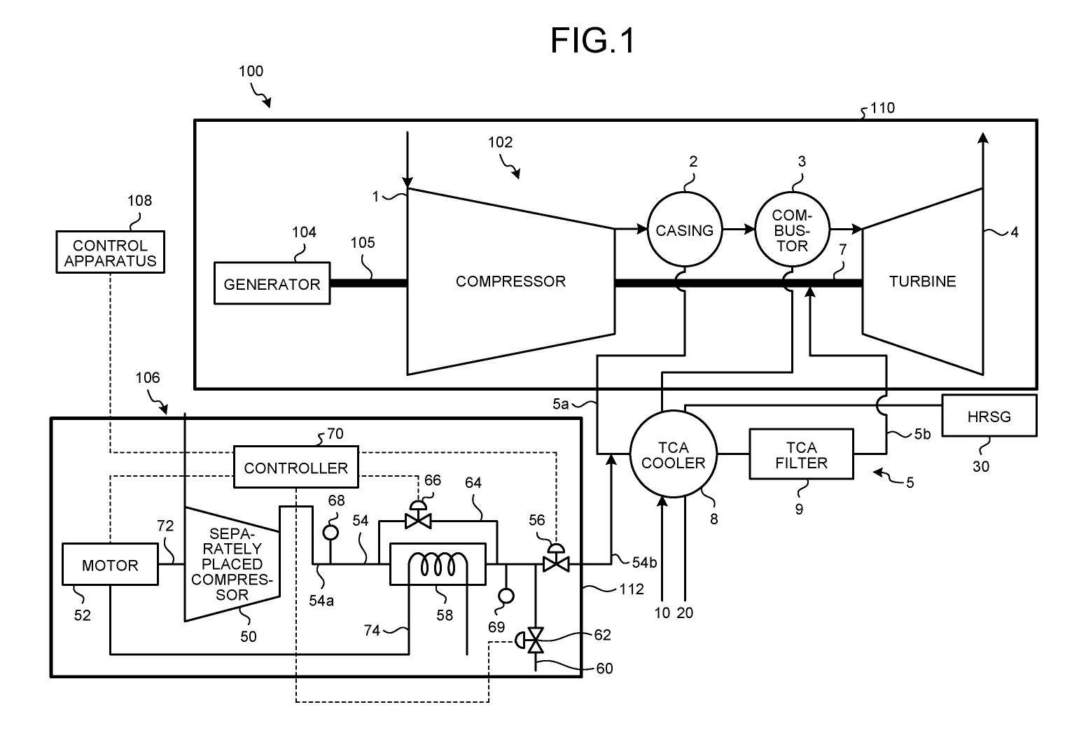

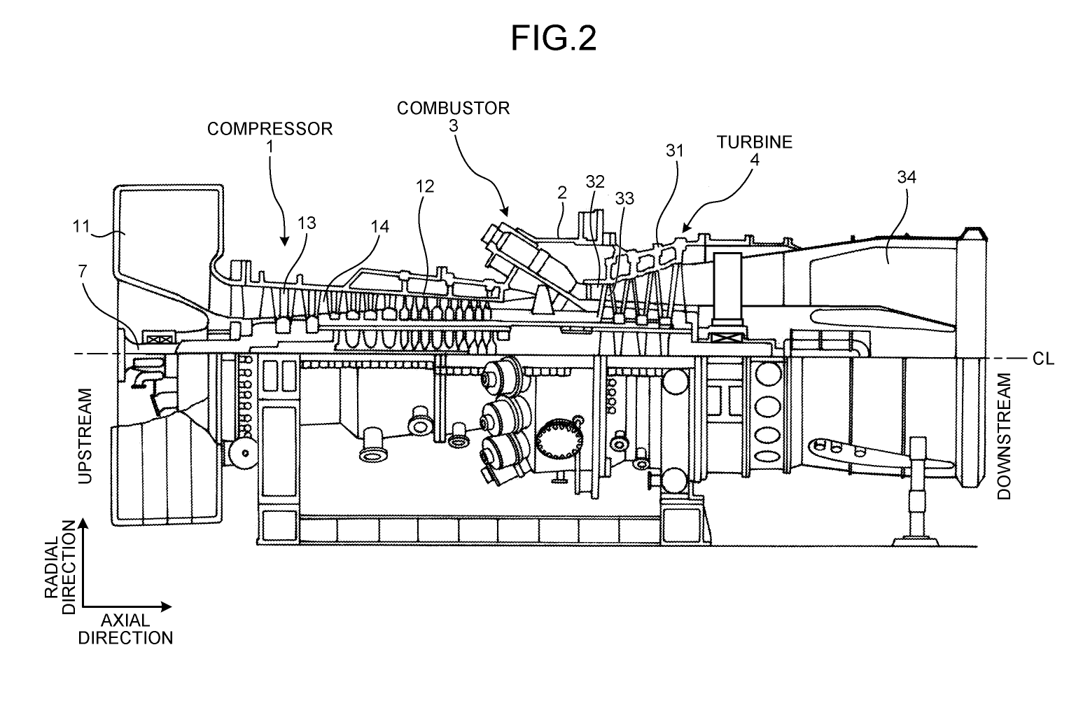

FIG. 1 is a diagram of a schematic configuration of a gas turbine plant according to a first embodiment of the present disclosure. FIG. 2 is a diagram of a schematic configuration illustrating an example of a gas turbine according to the first embodiment. As illustrated in FIG. 1, a gas turbine plant 100 has a gas turbine 102, a generator 104, an auxiliary compressed air supply apparatus 106, and a control apparatus 108. The control apparatus 108 controls operation of each unit of the gas turbine plant 100. The gas turbine plant 100 may include various structures included in a gas turbine plant, such as a flue gas treatment apparatus, which is not illustrated, and which is for treating flue gas discharged from the gas turbine 102. Further, in the gas turbine plant 100 of this embodiment, the gas turbine 102 is placed in a turbine building 110, the generator 104 is also placed in the turbine building 110, and the auxiliary compressed air supply apparatus 106 is placed in a separately placed building 112. Each unit of the gas turbine plant 100 arranged in the turbine building 110 and the separately placed building 112 is connected with pipings, through which compressed air flows.

As illustrated in FIG. 1 and FIG. 2, the gas turbine 102 has a compressor 1, a casing 2, a combustor 3, a turbine 4, a turbine cooling air (TCA) line 5, a turbine shaft 7, a TCA cooler 8, and a TCA filter 9. The compressor 1, the combustor 3, and the turbine 4 are arranged in a row in order from an upstream side to a downstream side of a flow direction of compressed air or combustion gas, along a shaft center CL of the turbine shaft 7. The compressor 1, the casing 2, the combustor 3, the turbine 4, a part of the TCA line 5, and the turbine shaft 7 of the gas turbine 102 are placed inside the turbine building 110. Further, a part of the TCA line 5, the TCA cooler 8, and the TCA filter 9 of the gas turbine 102 are arranged outside the turbine building 110.

The compressor 1 compresses air into compressed air. The compressor 1 is arranged inside a compressor casing 12 having an air inlet 11, through which air is taken in, and has plural stages of compressor vanes 13 and plural stages of compressor blades 14, provided therein. The compressor vanes 13 of the respective stages are attached to the compressor casing 12, and are arranged annularly in a circumferential direction; and the compressor blades 14 of the respective stages are attached to the turbine shaft 7, and are arranged annularly in the circumferential direction. These plural stages of compressor vanes 13 and plural stages of compressor blades 14 are alternately provided along an axial direction.

The casing 2 is a so-called compressor-combustor casing, and is connected with a final stage of the compressor 1, that is, a portion of the compressor 1 which is located closest to the turbine 4. Further, the casing 2 is connected to the TCA line 5. In the casing 2, compressed air having flowed in from the compressor 1 is supplied to the combustor 3, and some of the compressed air is supplied to the TCA line 5.

By supplying fuel to the compressed air compressed by the compressor 1, the combustor 3 generates high temperature and high pressure combustion gas. The combustor 3 has, for example, a combustor basket that mixes and combusts the compressed air and the fuel together, a transition piece that guides the combustion gas from the combustor basket to the turbine 4, and an external cylinder that covers an outer periphery of the combustor basket and guides the compressed air from the compressor 1 to the combustor basket. A plurality of the combustors 3 is arranged in the casing 2 in the circumferential direction.

The turbine 4 generates rotary power by the combustion gas generated in the combustor 3. In the turbine 4, plural stages of turbine vanes 32 and plural stages of turbine blades 33, which are arranged in a turbine casing 31, are provided. The turbine vanes 32 of the respective stages are attached to the turbine casing 31, and are arranged annularly in the circumferential direction, and the turbine blades 33 of the respective stages are fixed to an outer periphery of a discoidal disk centered around the shaft center CL of the turbine shaft 7, and are arranged annularly in the circumferential direction. These plural stages of turbine vanes 32 and plural stages of turbine blades 33 are provided alternately along the axial direction. Downstream in the axial direction of the turbine casing 31, a flue gas chamber 34, which has therein a diffuser continuous with the turbine 4, is provided.

One end portion of the TCA line 5 is connected to the casing 2, and the other end portion of the TCA line 5 is connected to a space formed inside a rotor (rotating unit) of the turbine 4. In a path of the TCA line 5, the TCA cooler 8 and the TCA filter 9 are provided. The TCA line 5 has an air bleeding piping 5a that connects the casing 2 to the TCA cooler 8, and an air bleeding piping 5b that feeds compressed air (cooling air), which has passed through the TCA cooler 8, to the rotor of the turbine 4.

The TCA cooler 8 is a heat exchanger provided in the TCA line 5. The TCA cooler 8 causes heat exchange between the compressed air supplied from the air bleeding piping 5a and a coolant to decrease temperature of the compressed air, and discharges the heat exchanged compressed air (cooling air) to the air bleeding piping 5b. The TCA filter 9 is arranged in the air bleeding piping 5b, that is, downstream from the TCA cooler 8 in the flow direction of the compressed air. The TCA filter 9 collects foreign substances included in the compressed air. Furthermore, the heat obtained by the heat exchange between the compressed air and a coolant of the TCA cooler 8 may be used for heating the fuel 10 supplied to the combustor of the gas turbine or heating supplied water 20 supplied to a heat recovery steam generator (HRSG) 30 in gas turbine combined cycle (GTCC). In this case, total efficiency of the gas turbine can be improved.

As described above, the TCA cooler 8 and the TCA filter 9 are placed outside the turbine building 110. Therefore, parts of the air bleeding pipings 5a and 5b of the TCA line 5 are drawn outside the turbine building 110 and connected to the TCA cooler 8.

The generator 104 is connected to the turbine shaft 7 via a drive shaft 105. In the generator 104, by the drive shaft 105 rotating with the turbine shaft 7, rotational energy of the turbine shaft 7 is converted to electric energy.

The auxiliary compressed air supply apparatus 106 has a separately placed compressor 50, a motor 52, an auxiliary compressed air piping 54, a control valve 56, a heat exchanger 58, a blow piping 60, a blow control valve 62, a bypass piping 64, a bypass control valve 66, a first measuring unit 68, a second measuring unit 69, and a controller 70. Each unit of the auxiliary compressed air supply apparatus 106 is placed in the separately placed building 112.

The separately placed compressor 50 is a compressor provided separately from the compressor 1. As the separately placed compressor 50, a multistage centrifugal compressor may be used, for example.

The motor 52 is connected to the separately placed compressor 50 via the drive shaft 72. By rotating the drive shaft 72, the motor 52 rotates a rotor of the separately placed compressor 50 to drive the separately placed compressor 50. As the motor 52, a motor that rotates the separately placed compressor 50 by combusting fuel may be used. For example, a motor which combusts fossil fuel, such as a gas engine or a gasoline engine, may be used as the motor 52.

One end portion of the auxiliary compressed air piping 54 is connected to the separately placed compressor 50, and the other end portion thereof is connected to the TCA line 5a. The auxiliary compressed air piping 54 has an auxiliary compressed air piping 54a inside the separately placed building 112, and an auxiliary compressed air piping 54b outside the separately placed building 112. The auxiliary compressed air piping 54 feeds out auxiliary compressed air, which is air compressed by the separately placed compressor 50, to the TCA line 5a.

The control valve 56 is provided in the auxiliary compressed air piping 54. The control valve 56 is a valve that is able to cause switch-over between a state of feeding out the auxiliary compressed air, which is the air compressed by the separately placed compressor 50, to the TCA line 5a and a state of stopping the feeding, by being switched over between being open and being closed. Further, the control valve 56 may be a flow regulating valve with adjustable opening. By use of the flow regulating valve as the control valve 56, flow rate of compressed air, which flows through the auxiliary compressed air piping 54 and is supplied to the TCA line 5a, is able to be adjusted. Further, plural control valves 56 having different functions may be provided in the auxiliary compressed air supply apparatus 106.

The heat exchanger 58 is arranged upstream of the control valve 56 in a flow direction of the auxiliary compressed air in the auxiliary compressed air piping 54. The heat exchanger 58 has a flue gas supply flow channel 74 for flue gas discharged from the motor 52, and performs heat exchange between the flue gas flowing through the flue gas supply flow channel 74 as a heating medium and the auxiliary compressed air, to increase temperature of the auxiliary compressed air. The heat exchanger 58 may alternatively use any fluid other than the flue gas as the heating medium, as long as the temperature of the auxiliary compressed air is able to be increased. By heating the auxiliary compressed air with heat of the flue gas from the motor 52, temperature deviation between the compressed air from the compressor 1 and the compressed air from the separately placed compressor 50 can be reduced appropriately to reduce thermal stress to the air bleeding piping 5a without providing an additional heat source.

One end portion of the blow piping 60 is connected to a portion of the auxiliary compressed air piping 54, the portion being downstream of the heat exchanger 58 and upstream of the control valve 56 in the flow direction of the auxiliary compressed air, and the other end portion thereof is open to the atmosphere. The blow control valve 62 is arranged in the blow piping 60. The blow control valve 62 is an on-off valve that is able to be switched over between being open and being closed. By providing the blow piping 60 and blow control valve 62 in the auxiliary compressed air piping 54, the auxiliary compressed air supply apparatus 106 is able to be switched over between a state where the auxiliary compressed air flowing through the auxiliary compressed air piping 54 is discharged from the blow piping 60 to the atmosphere and a state where the auxiliary compressed air flowing through the auxiliary compressed air piping 54 is not discharged to the atmosphere, by causing the blow control valve 62 to be switched between being open and being closed.

One end portion of the bypass piping 64 is connected to a portion of the auxiliary compressed air piping 54, the portion being upstream of the heat exchanger 58 in the flow direction of the auxiliary compressed air, and the other end portion thereof is connected to a portion of the auxiliary compressed air piping 54, the portion being downstream of the heat exchanger 58 and upstream of the portion connected to the blow piping 60 in the flow direction of the auxiliary compressed air. That is, the bypass piping 64 is a piping, through which the auxiliary compressed air flowing through the auxiliary compressed air piping 54 can bypass the heat exchanger 58. The bypass control valve 66 is arranged in the bypass piping 64. The bypass control valve 66 is a flow regulating valve, and by adjustment of its opening, ratio between compressed air passing through the heat exchanger 58 and compressed air bypassing the heat exchanger 58 is adjusted. By causing the auxiliary compressed air to bypass the heat exchanger 58 by the bypass piping 64 when overheating the auxiliary compressed air, temperature deviation between the compressed air from the compressor 1 and the compressed air from the separately placed compressor 50 can be reduced appropriately to reduce thermal stress to the air bleeding piping 5a without providing an additional heat source.

The first measuring unit 68 is arranged at a portion of the auxiliary compressed air piping 54, the portion being between the separately placed compressor 50 and the heat exchanger 58. The first measuring unit 68 measures a state of the auxiliary compressed air discharged from the separately placed compressor 50. The second measuring unit 69 is arranged at a portion of the auxiliary compressed air piping 54, the portion being between the portion connected to the bypass piping 64 and the control valve 56. The second measuring unit 69 measures a state of the auxiliary compressed air after parts of the auxiliary compressed air which have flowed through the auxiliary compressed air piping 54 and of which one part has passed through the heat exchanger 58 and the other part has passed through the bypass piping 64 join with each other. The first measuring unit 68 and the second measuring unit 69 measure temperature and pressure as the states of the auxiliary compressed air.

Based on a command from the control apparatus 108 and results of the measurement by the first measuring unit 68 and second measuring unit 69, the controller 70 controls operation of each unit of the auxiliary compressed air supply apparatus 106, specifically, each of the motor 52, the control valve 56, the blow control valve 62, and the bypass control valve 66.

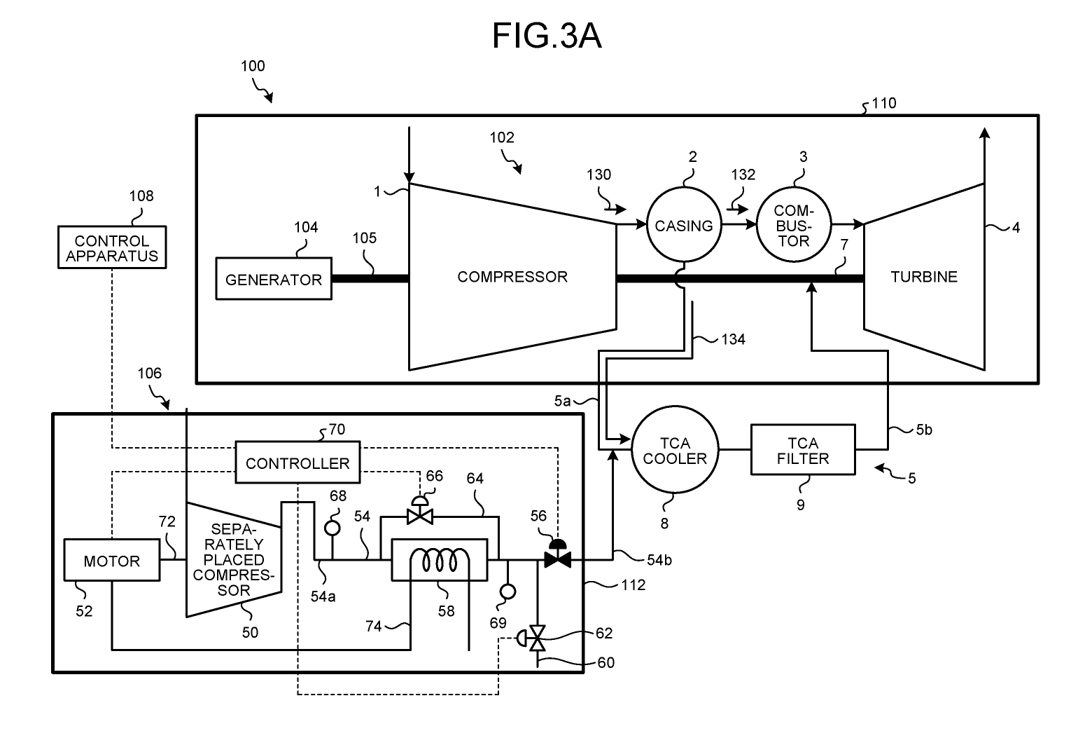

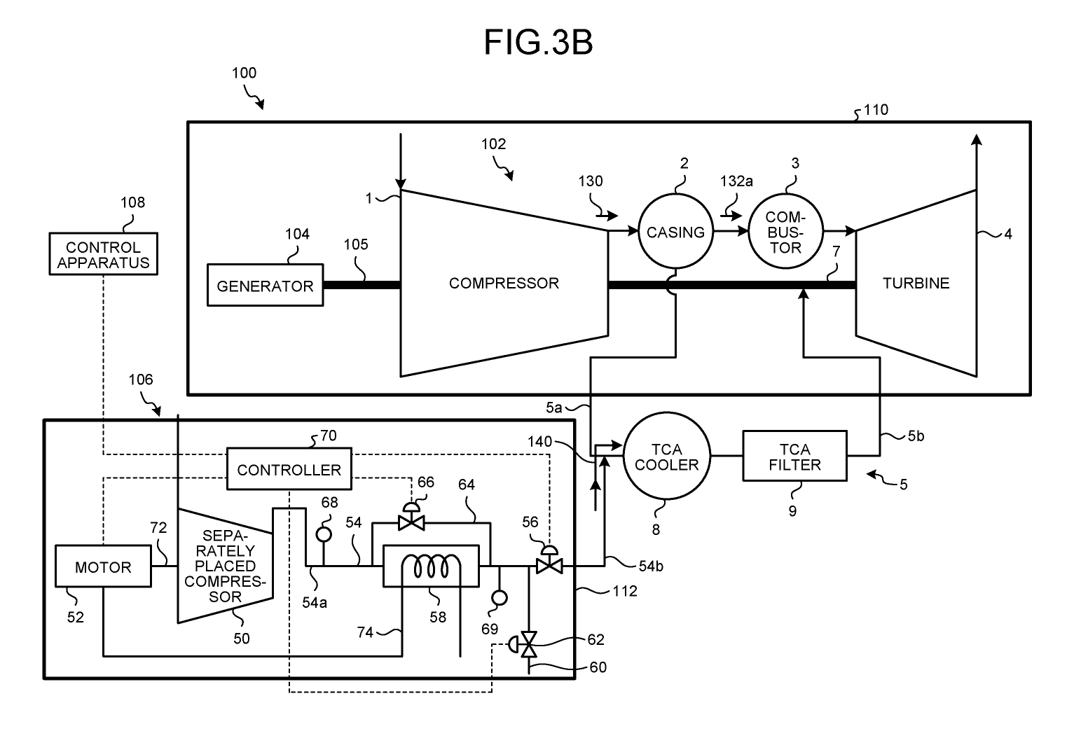

Next, operation of the gas turbine plant 100 will be described with reference to FIG. 1, FIG. 2, FIG. 3A and FIG. 3B. FIGS. 3A and 3B are explanatory diagrams each illustrating an example of the operation of the gas turbine plant according to the first embodiment. FIG. 3A illustrates operation of the gas turbine plant in a stopped state of the auxiliary compressed air supply apparatus 106. FIG. 3B illustrates operation of the gas turbine plant in an operating state of the auxiliary compressed air supply apparatus 106.

Firstly, the operation of the gas turbine plant 100 when the auxiliary compressed air supply apparatus 106 is in the stopped state will be described with reference to FIG. 3A. In the gas turbine plant 100 illustrated in FIG. 3A, the control valve 56 is closed. In the gas turbine plant 100, when the turbine shaft 7 is rotated, air is taken in from the air inlet 11 of the compressor 1. The air taken into the compressor 1 is compressed by passing through the plural stages of the compressor vanes 13 and plural stages of the compressor blades 14, thereby becoming high temperature and high pressure compressed air. Compressed air 130 generated in the compressor 1 flows into the casing 2, and compressed air 132, which is a part of the compressed air 130, is supplied to the combustor 3. Further, compressed air 134, which is another part of the compressed air 130, is supplied to the air bleeding piping 5a from the casing 2.

In the gas turbine plant 100, the combustor 3 mixes fuel into the compressed air 132 to combust the fuel and thereby generates combustion gas. In the gas turbine plant 100, by the combustion gas passing through the plural stages of the turbine vanes 32 and plural stages of the turbine blades 33 of the turbine 4, the turbine shaft 7 is rotationally driven. In the gas turbine plant 100, by the turbine shaft 7 rotating and the drive shaft 105 rotating integrally with the turbine shaft 7, the generator 104 generates electricity. Further, the combustion gas after the turbine shaft 7 is rotationally driven is discharged from the flue gas chamber 34 to outside of the system.

Further, of the compressed air 130 compressed by the compressor 1, the compressed air 134 supplied to the air bleeding piping 5a is cooled down by passing through the TCA cooler 8, and foreign substances therein is removed by the TCA filter 9. The compressed air 134 is supplied to the rotor of the turbine 4, that is, to the turbine shaft 7 and the turbine blades 33 to cool down the turbine shaft 7 and the turbine blades 33.

When atmospheric temperature increases, density of air is decreased and mass flow rate of air taken in by the compressor 1 is reduced, and thus gas turbine output is reduced. In the gas turbine plant 100 of this embodiment, the auxiliary compressed air supply apparatus 106 is activated in order to increase the gas turbine output reduced due to the above mentioned reason when the gas turbine 102 is operating at a rated value.

When the auxiliary compressed air supply apparatus 106 is activated, the controller 70 drives the motor 52 to cause the separately placed compressor 50 to generate compressed air. Upon the activation, the controller 70 closes the control valve 56 and opens the blow control valve 62. Upon the activation, the auxiliary compressed air discharged from the separately placed compressor 50 is in a state of having pressure lower than a predetermined pressure and also having low temperature, and thus is discharged outside from the blow piping 60. Further, the controller 70 adjusts the opening of the bypass control valve 66 to adjust flow rate of the auxiliary compressed air passing through the heat exchanger 58.

The controller 70 opens the control valve 56 when a state of the auxiliary compressed air measured by the second measuring unit 69 satisfies a predetermined condition. This predetermined condition may be, for example, a pressure of the auxiliary compressed air being a value higher than a pressure of the compressed air 132 flowing into the casing 2 and a temperature of the auxiliary compressed air being a value close to a temperature of the compressed air 130 flowing into the casing 2. When the control valve 56 is opened, supply of the auxiliary compressed air from the auxiliary compressed air supply apparatus 106 to the gas turbine 102 is started.

In the gas turbine plant 100, by the control valve 56 being opened, as illustrated in FIG. 3B, the auxiliary compressed air 140 is supplied to the air bleeding piping 5a, to which the auxiliary compressed air piping 54b is connected, from the auxiliary compressed air supply apparatus 106. In the gas turbine plant 100, by the supply of the auxiliary compressed air 140, as compared to the stopped state of the auxiliary compressed air supply apparatus 106, of the compressed air 130 generated by the compressor 1, the compressed air 134 supplied from the casing 2 to the air bleeding piping 5a is reduced and compressed air 132a supplied to the combustor 3 is increased. Thereby, in the gas turbine plant 100, more of the compressed air 130 generated by the compressor 1 is able to be supplied to the combustor 3, and the flow rate of the combustion gas generated by the combustor 3 is able to be increased. Therefore, the gas turbine plant 100 enables the gas turbine output to be increased and the electric power generation to be increased. Further, since the auxiliary compressed air 140 supplied from the auxiliary compressed air supply apparatus 106 is supplied to the gas turbine 102 as the cooling air, each unit of the gas turbine 102 is able to be cooled down appropriately.

As described above, the gas turbine plant 100 of this embodiment includes the auxiliary compressed air supply apparatus 106, which has the separately placed compressor 50 that is able to supply the auxiliary compressed air 140, which is compressed air different from the compressed air 130 generated by the compressor 1, to the gas turbine 102. Thus, the gas turbine plant 100 enables the gas turbine output to be increased, by use of the compressed air 130 compressed by the compressor 1 and the auxiliary compressed air 140 compressed by the separately placed compressor 50.

Further, the gas turbine plant 100 of this embodiment enables the amount of compressed air, which is a part of the compressed air 130 generated by the compressor 1 and used as the cooling air for cooling down the rotor of the turbine 4, to be reduced or to be zero, by use of the auxiliary compressed air 140 supplied from the auxiliary compressed air supply apparatus 106 as the cooling air for cooling down the rotor of the turbine 4. Thereby, while the flow rate of the compressed air supplied to the combustor 3 from the compressed air 130 generated by the compressor 1 is able to be increased, the cooling air for cooling the rotor of the turbine 4 is able to be acquired.

In the gas turbine plant 100, the auxiliary compressed air piping 54, through which the auxiliary compressed air 140 compressed by the separately placed compressor 50 flows, is connected to the TCA line 5. Specifically, the auxiliary compressed air piping 54 is connected to the air bleeding piping 5a that feeds out the compressed air (cooling air) bled off from the casing 2 to the TCA cooler 8. That is, the auxiliary compressed air 140 supplied from the auxiliary compressed air supply apparatus 106 passes through the TCA line 5 having the TCA cooler 8 and the TCA filter 9, to be supplied to the gas turbine 102 and used as the cooling air for cooling down the rotor of the turbine 4.

Thereby, as compared to, for example, a case of a structure where auxiliary compressed air is supplied to a casing (compressor-combustor casing) like of a conventional technique, the gas turbine plant 100 of this embodiment can suppress change of the compressed air supplied to the combustor 3. That is, by the auxiliary compressed air and the compressed air being mixed and supplied to the combustor 3, fluctuation in the combustion state in the combustor 3 can be reduced. Therefore, deviation in density of air for combustion due to a temperature difference between the auxiliary compressed air and the compressed air, and resulting difference in the combustion state among the combustors can be reduced or prevented. Therefore, limit on the operation due to an interlock caused by increase in the deviation of temperature of the combustion gas flowing in the flue gas chamber 34, and adverse influence on the turbine parts due to ununiformity of flow of the combustion gas inside the turbine caused by the deviation of temperature of the combustion gas can be reduced.

Further, for supplying auxiliary compressed air to a casing like in the conventional technique, a structure, where a manifold or the like is provided to supply the auxiliary compressed air from plural positions in a circumferential direction of the casing, may be considered. However, due to insufficient space around the casing, the structure becomes a structure circumventing existing pipings, and thus a manifold with a complex shape needs to be provided therein. In contrast, since the gas turbine plant 100 of this embodiment has the structure, where the auxiliary compressed air piping 54b is connected to the air bleeding piping 5a placed outside the turbine building 110, the structure for supplying the auxiliary compressed air is able to be simplified.

Furthermore, the gas turbine plant 100 of this embodiment enables generation of thermal stress in the air bleeding piping 5a to be reduced by decreasing the temperature difference between the compressed air 130 generated by the compressor 1 and the auxiliary compressed air 140 supplied from the auxiliary compressed air supply apparatus 106. Moreover, by the structure, where the auxiliary compressed air piping 54b for supplying the auxiliary compressed air 140 is connected upstream of the TCA cooler 8, the gas turbine plant 100 of this embodiment enables the changes in the cooling air supplied to the rotor of the turbine 4 to be small between the case where the compressed air 134 is used as the cooling air and the case where the auxiliary compressed air 140 is used as the cooling air. Therefore, even if the auxiliary compressed air 140 is used as the cooling air for the rotor of the turbine 4, cooling effect, which is the same as that in the case where the compressed air 134 is used as the cooling air, is able to be obtained. Furthermore, the auxiliary compressed air piping 54b connected to the air bleeding piping 5a may be connected downstream of the TCA cooler 8. In this case, an effect of being able to increase flow rate of gas flowing to the gas turbine to improve output of the gas turbine while suppressing increase in load on the gas turbine, is achieved, as in the case in which the auxiliary compressed air piping 54b is connected to upstream of the TCA cooler 8.

In the gas turbine plant 100 of this embodiment, the controller 70 starts supplying the auxiliary compressed air 140, when pressure of the auxiliary compressed air 140 becomes higher than pressure of the compressed air 132 supplied to the casing 2 from the compressor 1. Therefore, even if a control valve is not provided in the air bleeding piping 5a, through which the compressed air 134 flows, the supplied auxiliary compressed air 140 flows into the air bleeding piping 5a and flows towards the TCA cooler 8. Further, even if the supply of the auxiliary compressed air 140 from the auxiliary compressed air supply apparatus 106 is stopped due to an unexpected phenomenon, the compressed air 134 generated by the compressor 1 flows into the air bleeding piping 5a, and thus cooling of the rotor of the turbine 4 is able to be maintained appropriately.

The gas turbine plant 100 of the above described embodiment can also be realized by an improvement of installing the auxiliary compressed air supply apparatus 106 in an existing gas turbine plant not including the auxiliary compressed air supply apparatus 106.

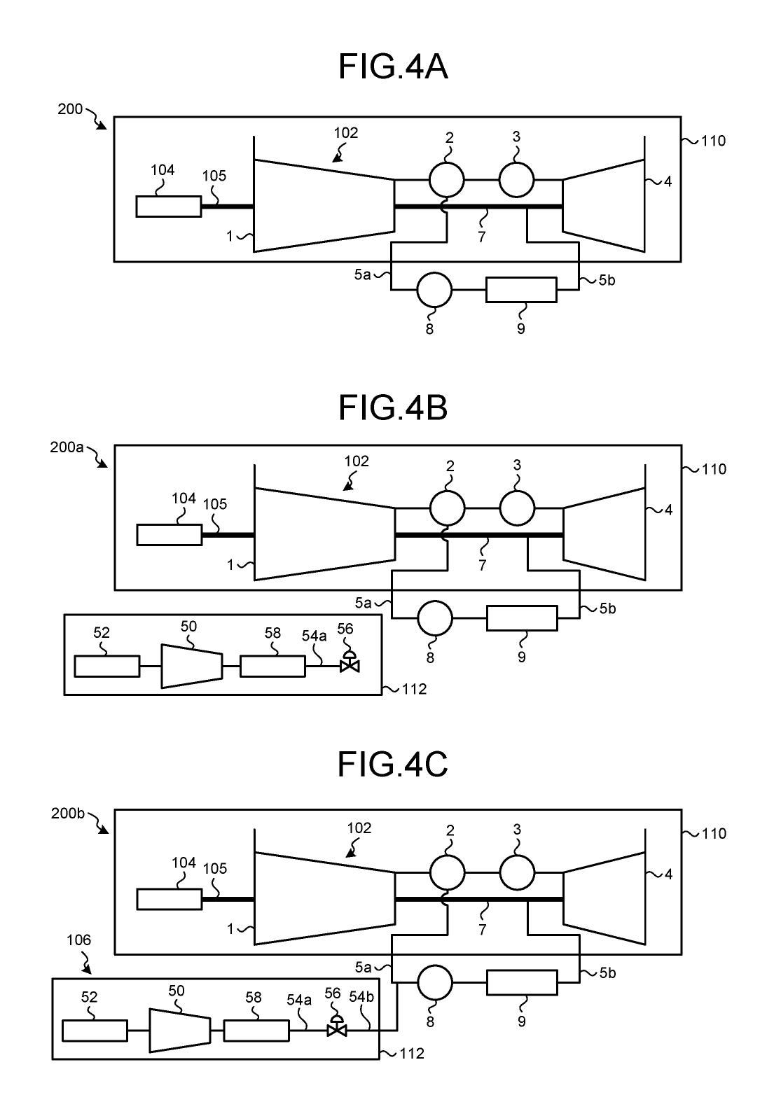

Hereinafter, an example of a method of the improvement will be described with reference to FIG. 4A to FIG. 4C. Each of FIGS. 4A to 4C is a diagram of a schematic configuration illustrating the example of the method of improving an existing gas turbine plant. An existing gas turbine plant 200 has, as illustrated in FIG. 4A, the gas turbine 102 and the generator 104. The gas turbine 102 and the generator 104 include the same units as the above described gas turbine plant 100 and description thereof will be omitted. Further, the gas turbine plant 200 also includes a control apparatus, and the like. The compressor 1, the turbine 4, the generator 104, and the like of the existing gas turbine plant 200 are installed in the turbine building 110. Further, the TCA cooler 8, the TCA filter 9, and a part of the TCA line 5 connected thereto are installed outside the turbine building 110. The TCA cooler 8 and the TCA filter 9 are installed outside the turbine building 110, and the air bleeding piping 5a connecting the compressor 1 to the TCA cooler 8, and the air bleeding piping 5b connecting the TCA cooler 8 to the turbine 4 extend from inside of the turbine building 110 to outside of the turbine building 110.

When the existing gas turbine plant 200 is to be improved, the separately placed compressor 50, the motor 52, the auxiliary compressed air piping 54a, the control valve 56, and the heat exchanger 58 of the auxiliary compressed air supply apparatus 106 are installed outside the turbine building 110 of the existing gas turbine plant 200a as illustrated in FIG. 4B. In addition, the blow piping 60, the blow control valve 62, the bypass piping 64, the bypass control valve 66, the first measuring unit 68, the second measuring unit 69, and the controller 70 may be installed further. That is, the units other than the auxiliary compressed air piping 54b of the auxiliary compressed air supply apparatus 106 are installed. Further, in this embodiment, the separately placed compressor 50, the motor 52, the auxiliary compressed air piping 54a, the control valve 56, and the heat exchanger 58 are installed inside the separately placed building 112.

As illustrated in the existing gas turbine plant 200a, after the separately placed compressor 50, the motor 52, the auxiliary compressed air piping 54a, the control valve 56, and the heat exchanger 58 are installed, the auxiliary compressed air piping 54b is connected to the air bleeding piping 5a arranged outside the turbine building 110 when the operation of the gas turbine 102 is in the stopped state. Thereby, the auxiliary compressed air supply apparatus 106 is able to be connected to the gas turbine 102 in the existing gas turbine plant 200b illustrated in FIG. 4C, and the improvement of providing the auxiliary compressed air supply apparatus 106 in the existing gas turbine plant 200 is able to be realized.

In this method of improving an existing gas turbine plant according to this embodiment, by providing the auxiliary compressed air supply apparatus 106 outside the turbine building 110, each unit of the auxiliary compressed air supply apparatus 106 is able to be installed when the existing gas turbine plant is in operation. Further, by this method of improving an existing gas turbine plant, work other than the work of connecting the auxiliary compressed air piping 54 to the air bleeding piping 5b is able to be performed without stopping the gas turbine. Thereby, during the work of the improvement, the operation of the gas turbine plant is able to be continued. Furthermore, since the work required to be done with the gas turbine stopped can be reduced, the improvement can be performed during a period of periodical check of the gas turbine plant, and thus the improvement is able to be performed with less influence on the operation of the gas turbine plant.

Further, in the method of improving an existing gas turbine plant, since a piping for supplying compressed air from the auxiliary compressed air supply apparatus 106 is installed in the TCA line, the piping is able to be installed in a portion arranged outside the turbine building 110. As described above, since the air bleeding piping 5a is outside the building, when the auxiliary compressed air piping 54 of the auxiliary compressed air supply apparatus 106 is connected to the air bleeding piping 5a, there is no need to work by carrying a part of the auxiliary compressed air supply apparatus 106 into the turbine building 110. Thereby, labor of a worker carrying the auxiliary compressed air supply apparatus 106 into the turbine building 110 is saved, and thus the work is able to be simplified and made highly efficient.

In the gas turbine plant 100 of the first embodiment, the auxiliary compressed air 140 is used as the rotor cooling air for cooling the turbine 4. In this case, even if the auxiliary compressed air 140 is used as the cooling air for the rotor of the turbine 4, cooling effect that is the same as that in a case where the compressed air 134 is used as the cooling air is able to be obtained, but the present disclosure is not limited to this embodiment. In the gas turbine plant, the auxiliary compressed air may be used as cooling air for others.

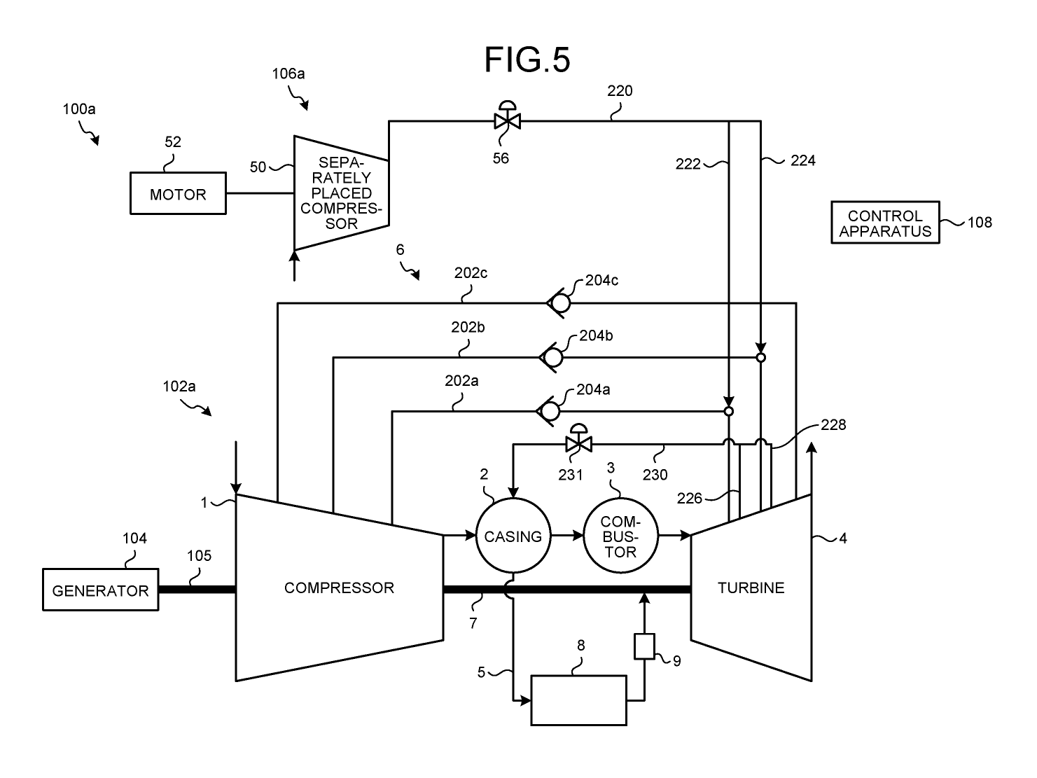

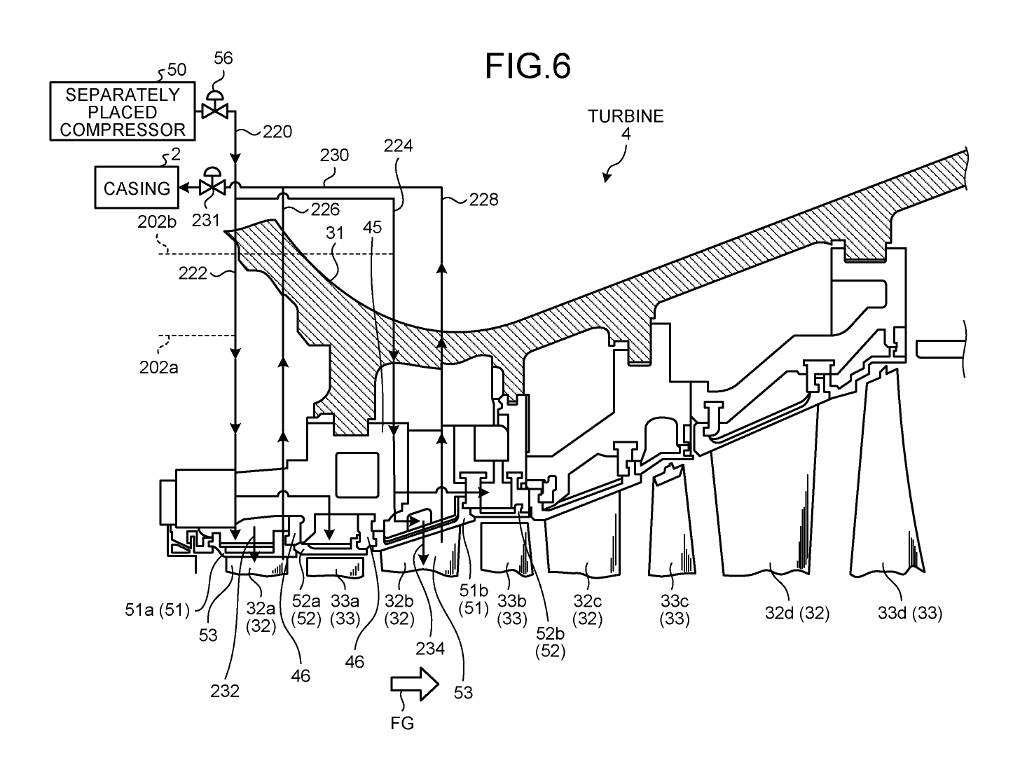

FIG. 5 is a diagram of a schematic configuration illustrating an example of a gas turbine plant according to a second embodiment. FIG. 6 is a diagram of a schematic configuration illustrating an example of a gas turbine and an auxiliary compressed air supply apparatus, according to the second embodiment. A gas turbine plant 100a illustrated in FIG. 5 has a gas turbine 102a, the generator 104, an auxiliary compressed air supply apparatus 106a, and the control apparatus 108. Since the generator 104 and the control apparatus 108 have the same configurations as those of the gas turbine plant 100, description thereof will be omitted.

The gas turbine 102a is configured similarly to the gas turbine 102, and has the compressor 1, the casing 2, the combustor 3, the turbine 4, the turbine cooling air (TCA) line 5, the turbine shaft 7, the TCA cooler 8, and the TCA filter 9. Further, the gas turbine 102a includes a turbine blade cooling mechanism 6. The gas turbine 102 may also include the turbine blade cooling mechanism 6.

The turbine blade cooling mechanism 6 bleeds off the compressed air from stages in the middle of the compressor 1, and supplies the bled compressed air to a blade ring and turbine vanes of the turbine 4 to cool them down. The turbine blade cooling mechanism 6 bleeds off the compressed air from three stages in the middle of the compressor 1, and cools down the turbine vanes of separate stages of the turbine 4 respectively with the compressed air from the three stages.

The turbine blade cooling mechanism 6 has air bleeding pipings 202a, 202b, and 202c, and check valves 204a, 204b, and 204c. Portions at one end of the air bleeding pipings 202a, 202b, and 202c are connected to the compressor 1, and portions at the other end thereof are connected to the turbine 4. The air bleeding piping 202a is connected to a position at which the compressed air and the combustion gas with higher pressure than those in the air bleeding piping 202b flow. The air bleeding piping 202b is connected to a position at which the compressed air and combustion gas with higher pressure than those in the air bleeding piping 202c flow. The check valve 204a is provided in the air bleeding piping 202a. The check valve 204b is provided in the air bleeding piping 202b. The check valve 204c is provided in the air bleeding piping 202c. The check valves 204a, 204b, and 204c are valves, each of which restricts flow of compressed air to one direction, such that the compressed air flows from the compressor 1 towards the turbine 4 and the compressed air does not flow from the turbine 4 towards the compressor 1. The turbine blade cooling mechanism 6 supplies the compressed air bled off from the compressor 1 to the turbine 4, and causes the compressed air to pass through the turbine vanes, blade ring, casing, and the like of the turbine 4, to thereby cool them down in the region where the compressed air passed through. The compressed air supplied from the turbine blade cooling mechanism 6 to the turbine 4 is discharged, as film air or seal air, to a flow channel, through which combustion gas flows, or supplied to another region as cooling air for a lower pressure region.

The auxiliary compressed air supply apparatus 106a has the separately placed compressor 50, the motor 52, the control valve 56, supply pipings 220, 222, and 224, recovery pipings 226, 228, and 230, and a control valve 231. Similarly to the auxiliary compressed air supply apparatus 106, the auxiliary compressed air supply apparatus 106a may include the heat exchanger 58, the blow piping 60 and blow control valve 62, the bypass piping 64 and bypass control valve 66, a measuring unit, a controller, and the like. Since the separately placed compressor 50, the motor 52, and the control valve 56 have the same configurations as the respective units of the auxiliary compressed air supply apparatus 106, description thereof will be omitted.

The auxiliary compressed air supply apparatus 106a has, as pipings through which compressed air generated by the separately placed compressor 50 flows, the supply pipings 220, 222, and 224 and the recovery pipings 226, 228, and 230. One end portion of the supply piping 220 is connected to the separately placed compressor 50, and the other end portion thereof is connected to the supply piping 222 and the supply piping 224. One end portion of the supply piping 222 is connected to the supply piping 220, and the other end portion thereof is connected to the air bleeding piping 202a. One end portion of the supply piping 224 is connected to the supply piping 220, and the other end portion thereof is connected to the air bleeding piping 202b. One end portion of the recovery piping 226 is connected to the turbine 4, and the other end portion thereof is connected to the recovery piping 230. One end portion of the recovery piping 228 is connected to the turbine 4, and the other end portion thereof is connected to the recovery piping 230. One end portion of the recovery piping 230 is connected to the recovery piping 226 and recovery piping 228, and the other end portion thereof is connected to the casing 2. The control valve 231 is provided in the recovery piping 230. The control valve 231 is a valve for switching over between supplying and not supplying air having flowed into the recovery piping 230 to the casing 2.

Next, a path through which the auxiliary compressed air flows will be described with reference to FIG. 6. As illustrated in FIG. 6, the plural stages of turbine vanes 32 of the turbine 4 include, in order from an upstream side in a flow direction FG of the combustion gas, a first turbine vane 32a, a second turbine vane 32b, a third turbine vane 32c, and a fourth turbine vane 32d. The turbine vane 32 is integrally formed of an outer shroud 51, an airfoil portion 53 extending to an inner side in a radial direction from the outer shroud 51, and an inner shroud (not illustrated) provided at an inner side in the radial direction of the airfoil portion 53. Further, the turbine vane 32 is supported on the turbine casing 31 via a thermal insulation ring and a blade ring, and constitutes a part of a fixed side.

The plural stages of turbine blades 33 are respectively arranged opposite to plural ring segments 52 at an inner side in the radial direction. The turbine blades 33 of the respective stages are provided separately from the respective ring segments 52 with a predetermined gap therebetween, and constitute a part of a movable side. The plural stages of turbine blades 33 include, from the upstream side in the flow direction FG of the combustion gas, in the order of a first turbine blade 33a, a second turbine blade 33b, a third turbine blade 33c, and a fourth turbine blade 33d.

Therefore, the plural stages of turbine vanes 32 and the plural stages of turbine blades 33 are arranged, in order from the upstream side in the flow direction FG of the combustion gas, to have the first turbine vane 32a, the first turbine blade 33a, the second turbine vane 32b, the second turbine blade 33b, the third turbine vane 32c, the third turbine blade 33c, the fourth turbine vane 32d, and the fourth turbine blade 33d, and are provided opposite to each other in the axial direction.

As illustrated in FIG. 6, the turbine casing 31 has a blade ring 45 arranged at an inner side of the turbine casing 31 in the radial direction and supported on the turbine casing 31. The blade ring 45 is formed around the turbine shaft 7 in an annular shape, plurally divided in the circumferential direction and the axial direction, and supported on the turbine casing 31. A thermal insulation ring 46 is arranged at an inner side of the blade ring 45 in the radial direction, and the turbine vanes 32 are supported on the blade ring 45 via the thermal insulation ring 46. Inside the blade ring 45, the plural turbine vanes 32 and the plural ring segments 52 are provided adjacent to each other in the axial direction.

The supply piping 222 is connected to a space formed over an outer shroud 51a (51) of the first turbine vane 32a and a space formed over a ring segment 52a (52) forming the blade ring facing the first turbine blade 33a. Further, in the turbine 4, a space formed in the blade ring outside the outer shroud 51a (51) is connected to a cooling passage 232 formed in the outer shroud 51a of the first turbine vane 32a and the airfoil portion 53. Furthermore, the cooling passage 232 is connected to the recovery piping 226.

Next, the supply piping 224 is connected to a space formed over an outer shroud 51b (51) of the second turbine vane 32b and a space formed over a ring segment 52b (52) forming the blade ring facing the second turbine blade 33b. Further, in the turbine 4, a space formed in the blade ring outside the outer shroud 51b (51) is connected to a cooling passage 234 formed in the outer shroud 51b of the second turbine vane 32b and the airfoil portion 53. Furthermore, the cooling passage 234 is connected to the recovery piping 228.

In the gas turbine plant 100a, when the auxiliary compressed air supply apparatus 106a is in a stopped state, the control valve 56 and the control valve 231 are closed. In this case, in the gas turbine plant 100a, the compressed air bled off from the compressor 1 in the turbine blade cooling mechanism 6 is supplied to the turbine 4, and the respective parts of the turbine 4 are cooled down.

The auxiliary compressed air supply apparatus 106a is operated in order to increase the gas turbine output, similarly to the auxiliary compressed air supply apparatus 106. When a state of the auxiliary compressed air satisfies a predetermined condition, the auxiliary compressed air supply apparatus 106a opens the control valve 56 and the control valve 231. As to the predetermined condition, for example, when a pressure of the auxiliary compressed air generated by the separately placed compressor 50 of the auxiliary compressed air supply apparatus 106a becomes a suppliable pressure, that is, when a value of the pressure of the auxiliary compressed air becomes a value higher than a pressure of the compressed air supplied in the turbine blade cooling mechanism 6, the control valve 56 and the control valve 231 are opened. When the control valve 56 and the control valve 231 are opened, supply of the auxiliary compressed air to the turbine 4 is started from the auxiliary compressed air supply apparatus 106a, through the supply pipings 220, 222, and 224.

The auxiliary compressed air supplied from the supply piping 222 passes through the cooling passage 232 of the first turbine vane 32a after passing through the space formed in the blade ring outside the outer shroud 51a (51). The auxiliary compressed air that has passed through the cooling passage 232 flows into the casing 2 after passing through the recovery piping 226 and the recovery piping 230. Further, the auxiliary compressed air supplied from the supply piping 224 passes through the cooling passage 234 of the second turbine vane 32b after passing through the space formed in the blade ring outside the outer shroud 51b (51). The auxiliary compressed air that has passed through the cooling passage 234 flows into the casing 2 after passing through the recovery piping 228 and the recovery piping 230. Furthermore, similarly to the compressed air, some of the auxiliary compressed air is discharged, as seal air and film air, into the flow channel, through which the combustion gas flows. The auxiliary compressed air, which has flowed through the respective parts, has been used as the cooling air, and has been supplied from the recovery piping 230 to the casing 2, is supplied, to the combustor 3 together with the compressed air discharged from the compressor 1.

Thereby, in the gas turbine plant 100a, flow rate of the compressed air, which is a part of the compressed air compressed by the compressor 1 and supplied to the turbine 4 without passing through the combustor 3 for cooling, can be reduced. Thereby, more of the compressed air compressed by the compressor 1 is able to be supplied to the combustor.

Further, in the gas turbine plant 100a of this embodiment, the auxiliary compressed air compressed to a necessary pressure by the separately placed compressor 50 is fed to the blade ring of the turbine 4, and the turbine blade ring is cooled down by that auxiliary compressed air. Furthermore, in the gas turbine plant 100a, the auxiliary compressed air used in cooling the blade ring of the turbine 4 is fed to the first turbine vane 32a and second turbine vane 32b, and the turbine vanes of the respective stages are cooled down by the auxiliary compressed air. In the gas turbine plant 100a, the auxiliary compressed air that has cooled down the respective turbine vanes is recovered through the recovery pipings 226 and 228 connected to the cooling passages of the turbine vanes of the respective stages, and the recovered compressed air is supplied to the combustor 3 to be used as combustion air for gas turbine. In the gas turbine plant 100a, by using the auxiliary compressed air for cooling the turbine blade ring and turbine vanes, the flow rate of the compressed air compressed by the compressor and supplied as the cooling air to the turbine vanes can be reduced, and the flow rate of the compressed air flowing out to the flow channel of the combustion gas after being passed inside the turbine vanes can be reduced. Moreover, by recovering some of the auxiliary compressed air, even if the compressed air flowing through the turbine vanes and the like is increased, decrease in efficiency can be reduced.

In addition, in the gas turbine plant 100a, another compressor, which increases pressure of the auxiliary compressed air flowing through the recovery pipings, may be further provided separately.

The present disclosure has been made in view of the above, and can provide a gas turbine plant and a method of improving an existing gas turbine plant, which can suppress increase in load on a gas turbine, and increase flow rate of gas flowing to the gas turbine to improve output of the gas turbine.

According to the present disclosure, more of compressed air supplied from a compressor of a gas turbine is able to be used in combustion, by supplying compressed air supplied from a separately placed compressor as cooling air. Thereby, an effect of being able to increase flow rate of gas flowing to the gas turbine to improve output of the gas turbine while suppressing increase in load on the gas turbine, is achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A gas turbine plant, comprising:
a gas turbine having: a compressor configured to compress air; a combustor configured to mix compressed air compressed by the compressor with fuel to generate combustion gas; a turbine connected to the compressor and configured to acquire rotary power by the combustion gas; and an air bleeding piping configured to supply the compressed air bled off from the compressor to the turbine as cooling air; and
an auxiliary compressed air supply apparatus having: a separately placed compressor different from the compressor; a motor configured to rotate the separately placed compressor; and an auxiliary compressed air piping configured to connect the separately placed compressor to the air bleeding piping to supply auxiliary compressed air compressed by the separately placed compressor to the air bleeding piping, wherein
the gas turbine includes a cooling apparatus connected to the air bleeding piping and configured to cool down the cooling air.

2. The gas turbine plant according to claim 1, wherein the auxiliary compressed air piping is connected to a portion between the cooling apparatus and the compressor of the air bleeding piping.

3. The gas turbine plant according to claim 1, wherein the air bleeding piping is configured to supply the cooling air cooled down by the cooling apparatus to the turbine.

4. The gas turbine plant according to claim 1, further comprising a control valve provided in the auxiliary compressed air piping and a controller configured to open the control valve when the auxiliary compressed air generated in the separately placed compressor satisfies a predetermined condition to supply the auxiliary compressed air to the air bleeding piping via the auxiliary compressed air piping.

5. The gas turbine plant according to claim 4, wherein the controller blows out the auxiliary compressed air generated, until the predetermined condition is satisfied.

6. The gas turbine plant according to claim 1, wherein the separately placed compressor is a multistage compressor.

7. The gas turbine plant according to claim 1, wherein a heat exchanger is provided in the auxiliary compressed air piping.

8. The gas turbine plant according to claim 7, wherein a bypass piping configured to bypass the heat exchanger is provided in the auxiliary compressed air piping.

9. The gas turbine plant according to claim 7, wherein the heat exchanger is configured to perform heat exchange between flue gas and the auxiliary compressed air.

10. The gas turbine plant according to claim 1, wherein the cooling apparatus is configured to heat the fuel or supplied water to the gas turbine with the heat obtained by heat exchange with the compressed air.

11. A method of improving an existing gas turbine plant comprising: a compressor arranged in a turbine building; a combustor arranged in the turbine building and configured to mix compressed air compressed by the compressor with fuel to generate combustion gas; a turbine arranged in the turbine building and configured to acquire rotary power by the combustion gas; and an air bleeding piping configured to supply the compressed air bled off from the compressor to the turbine as cooling air; and a cooling apparatus connected to the air bleeding piping and configured to cool down the cooling air, the method comprising:
arranging, outside the turbine building, auxiliary compressed air supply equipment including a separately placed compressor configured to generate compressed air and a motor configured to drive the separately placed compressor; and
connecting an auxiliary compressed air piping, through which the auxiliary compressed air generated by the separately placed compressor of the auxiliary compressed air supply equipment flows, to a portion of the air bleeding piping, the portion being arranged outside the turbine building.
